(19) United States
(12) Patent Application Publication
(10) Pub. No.: US 2013/0318916 A1
(43) Pub. Date: Dec. 5, 2013

(54) PACKAGING FOR A LIQUID FILLING MATERIAL, AND METHOD AND DEVICE FOR PRODUCING IT

(71) Applicants: Henno Hensen, Bremen (DE); Harald Saelens, Marke (BE)

(72) Inventors: Henno Hensen, Bremen (DE); Harald Saelens, Marke (BE)

(73) Assignee: SCALDOPACK SPRL., Dottignies (BE)

(21) Appl. No.: 13/824,138

(22) PCT Filed: Dec. 19, 2011
(86) PCT No.: PCT/EP2011/073173

§ 371 Date: Apr. 19, 2013

(30) Foreign Application Priority Data
Feb. 21, 2011 (DE) 10 2011 011 883.7

(51) Int. Cl. B65B 1/00

(52) U.S. Cl. CPC B67D 7/80; B65D 21/00; B65D 81/18; B65B 3/00
USPC 53/266.1; 220/23.86; 53/467

(57) ABSTRACT

A packaging for a liquid filling with a product packaging pouch made out of a liquid-tight and elastic material and having a reaction chamber pouch made out of a liquid-tight and elastic material. The reaction chamber pouch is completely closed, and is arranged inside the product packaging pouch and partially filled with a first reactant. An inner pouch made out of a liquid-tight and elastic material is completely closed, is arranged inside the reaction chamber pouch and exhibits a predetermined breaking point that yields when its interior pressure is increased, and is filled with a second reactant. The first and second reactant induce a temperature change upon coming into contact with each other. As a result, a temperature change can be initiated by the user on the one hand, while minimizing the risk that the filling will become contaminated with chemicals on the other.

The present invention relates to a packaging for a liquid filling, in particular a liquid food, e.g. a beverage, or a non-food, with a product packaging pouch made out of a liquid-tight and elastic material and with a reaction chamber pouch made out of a liquid-tight and elastic material, wherein the reaction chamber pouch is completely closed, arranged inside the product packaging pouch and partially filled with a first reactant.

Packagings for a liquid filling with a liquid-tight and elastic product packaging pouch are sufficiently known. For example, such a product packaging pouch involves a stand-up pouch that extends from a bottom comprising a base in a longitudinal direction to an upper end, and exhibits a spout with a seal, in particular a screw cap, through which the liquid filling, i.e., the product, can be filled and removed. For example, a packaging that encompasses such a product packaging pouch is known from DE 599 03 381 A1 or EP 0 989 069 A2.

Also known are packagings for a liquid filling with a product packaging pouch that is not necessarily a stand-up pouch, wherein the product packaging pouch contains a separate, entirely freely movable reaction chamber pouch, inside of which a chemical reaction is initiated to induce a temperature change. To this end, the interior of the reaction chamber pouch exhibits two reactants separated from each other, which are provided in different sections of the reaction chamber pouch separated from each other. When the user of the packaging exerts pressure from outside on the reaction chamber pouch, the reactants that had previously been separated from each other are brought into contact with each other, thereby triggering an exothermic or endothermic reaction, depending on the reactants selected. In turn, the latter induces a temperature change in the form of a temperature rise or temperature drop, wherein thermal conduction correspondingly also changes the temperature of the liquid filling in the product packaging pouch. In other words, a liquid filling, for example a beverage, can be heated or cooled by exerting an external pressure on the reaction chamber pouch and thereby triggering a chemical reaction inside the reaction chamber pouch, depending on which reactants are provided in the reaction chamber pouch.

The problem with respect to the packaging described above with a reaction chamber pouch arranged in the product packaging pouch is that the pressure exerted by the user on the reaction chamber pouch gives rise to the danger that the outer sealed seam of the reaction chamber pouch will open, causing the reactant or reactants to come into contact with the filling, for example, the beverage. This only detracts from the taste of the product in the best case scenario, while poisoning consumers in the worst case scenario.

Therefore, the object of the present invention is to provide a packaging for a liquid filling with which a temperature change inside the packaging can be initiated by the user on the one hand, while minimizing the risk that the liquid filling will become contaminated with chemicals on the other.

The object derived and specified above is achieved according to a first teaching of the present invention by a packaging for a liquid filling, in particular a liquid food or non-food,
with a product packaging pouch made out of a liquid-tight and elastic material, for example a commercially available stand-up pouch and/or a pouch with spout;
with a reaction chamber pouch made out of a liquid-tight and elastic material, wherein the reaction chamber pouch is completely closed, arranged inside the product packaging pouch (i.e., the reaction chamber pouch is completely enclosed by the product packaging pouch), and partially filled with a first solid, liquid and/or gaseous reactant, e.g., in tablet form, and
with an inner pouch made out of a liquid-tight and elastic material, wherein the inner pouch is completely closed, arranged inside the reaction chamber pouch (i.e., the inner pouch is completely enclosed by the reaction chamber pouch), exhibits a predetermined breaking point that yields (breaks) when its interior pressure is increased (for example, by a pressure exerted on the pouch by the user), and is filled with a second solid, liquid and/or gaseous reactant, e.g., water,
   wherein the first and second reactant induce a temperature change when they come into contact with each other, specifically as the result of an endothermic or exothermic reaction.

The liquid can be selected from the group encompassing liquids for preparing foods (beverages), such as hot coffee, hot tea, hot cocoa, iced tea, Frappuccino or the like. The liquid can also be selected from the group encompassing liquids for preparing baby food, such as hot water (for dissolving powdered beverages), ready-made baby beverages or the like, wherein the spout can also be designed as a nipple (teat), or connectable with one. The liquid can further be selected from the group encompassing pharmaceutical liquids, such as concentrated juice (sirup) to be heated, medicine to be heated, medicine to be cooled, or pharmaceutical aids, such as (for example, germ-free) water to be heated, liquids for cooling elements or the like. The liquid can also be selected from the group encompassing liquids for manufacturing cosmetic products or cosmetic liquids, for example waxes to be heated, massage or caring oils, hair or facial masks, dermatological products to be heated or cooled, skin cremes to be cooled, in particular for use after sunbathing (after sun lotion), or the like. The liquid can also be one selected from the group encompassing liquids for industrial or manufacturing applications, for example adhesives to be heated, paints, resins, silicones or the like. Also conceivable are liquids selected from the group encompassing liquids for humanitarian purposes or caring for soldiers, in particular for preparing warm meals, warm or cold beverages, for applications involving emergency (first-aid) equipment, or the like.

Providing a separate inner pouch containing one of the two reactants, i.e., reacting agents, in the reaction chamber pouch makes it possible that, in a pouch in which a sealed seam is intended to open through exposure to external pressure, it is not dangerous if a sealing seam in this pouch opens at a location other than the one envisaged, even inadvertently. The inner pouch, in this case the pouch to be positioned in a location where it will burst open, is completely enveloped by the reaction chamber pouch, so that the liquid filling, for example the beverage, cannot be contaminated even if the inner pouch bursts open at an unexpected location.

In an embodiment of the packaging according to the invention, the product packaging pouch and reaction chamber pouch each have a separate pouch sheath, and hence a separate pouch wall, meaning that they are separate pouches independent of each other. In particular the entire pouch sheath of the reaction chamber pouch can be displaced relative to the entire pouch sheath of the product packaging pouch. Displaced means that the two separate pouches can be moved relative to each other not just in sections, but can be shifted completely relative to each other. Accordingly, the reaction chamber pouch and inner pouch in one embodiment each also have a separate pouch sheath or wall, i.e., are also separate pouches independent of each other, wherein in particular the entire pouch sheath of the inner pouch can be displaced relative to the entire pouch sheath of the reaction chamber pouch. In other words, the individual pouches are not integrally bonded with each other. By contrast, the invention does not preclude contact between the pouches. However, it does rule out two pouches sharing a common pouch sheath and a common sealed seam.

In another embodiment of the packaging according to the invention, the product packaging pouch has a lower end forming a bottom, from which the product packaging pouch extends over a length vertically in the longitudinal direction toward an upper end, wherein the reaction chamber pouch extends in the longitudinal direction over at least 50%, preferably at least 70%, especially preferably at least 90%, of the length of the product packaging pouch. This gives the reaction chamber pouch a relatively large surface by comparison to the product packaging pouch, and hence by comparison to the liquid filling, over which the liquid filling can be made to undergo a relatively quick temperature change, e.g., heated or cooled, via thermal transfer. In addition, increasing the size of the reaction chamber pouch relative to the size of the product packaging pouch also prevents the reaction chamber pouch from floating in the product packaging pouch. In other words, the reaction chamber pouch is kept at the optimal location provided for thermal transfer.

In order to be able to retain the reaction chamber pouch at the optimal location within the product packaging pouch even more effectively, another embodiment provides that at least sections of the reaction chamber pouch be friction fit relative to the product packaging pouch with the product packaging pouch in a filled and/or unfilled state. The friction fit also prevents the reaction chamber pouch from undesirably floating. In particular, the friction fit can be achieved by having the product packaging pouch and reaction chamber pouch each exhibit at least one lateral sealed seam, and, with the product packaging pouch in a filled and/or unfilled state, by having the outer edge of a lateral sealed seam of the reaction chamber pouch abut against the inner edge of a lateral sealed seam of the product packaging pouch, especially under a pressure.

When in the filled and/or unfilled state, the product packaging pouch can further have a waisted form. A waisted form is suitable in particular for bringing about a friction fit between the interior side of the product packaging pouch and the exterior side of the reaction chamber pouch.

In this regard, it is especially preferred in the filled state of the product packaging pouch for more than 50%, preferably more than 70%, especially preferably more than 90%, of the outer surface of the reaction chamber pouch to be spaced apart from the inner surface of the product packaging pouch. Therefore, the reaction chamber pouch is predominantly, if not completely, enveloped by the liquid filling. This effect can be supported even further by a corresponding friction fit between the reaction chamber pouch and product packaging pouch, in particular also by the waisted form, since the reaction chamber is held at the optimal location, as stated. Because the reaction chamber pouch is completely or at least predominantly enveloped by the liquid filling, direct contact between the reaction chamber pouch and product packaging pouch is also largely avoided, which in turn prevents the relatively high reaction temperatures from damaging the product packaging pouch. Depending on the selected reactants, temperatures measuring 100° C. or even more are entirely possible, so that the reaction chamber pouch would inevitably also become correspondingly hot if it were unable to release its heat to the liquid filling. Given a large contact surface between the reaction chamber pouch and product packaging pouch, the heat would thus be released from the reaction chamber pouch directly to the product packaging pouch, thereby potentially damaging the latter.

Undesired contact between the exterior side of the reaction chamber pouch and interior side of the product packaging pouch can further be prevented by having the reaction chamber pouch be evacuated according to another embodiment, meaning void of air. This can take place before closing the reaction chamber pouch, and additionally offers the advantage of correspondingly reducing the air humidity inside the reaction chamber pouch, so that moisture-sensitive constituents, for example tablets, can be filled into the reaction chamber pouch as a first reactant. Another advantage to evacuation is that a compressive force exerted by the user can be directly conveyed to the inner pouch, thereby further reducing the risk that sealed seams of the reaction chamber pouch will burst open.

In yet another embodiment of the packaging according to the invention, the inner pouch is situated vertically above the first reactant in the reaction chamber pouch relative to the longitudinal direction. Since the product packaging pouch can as mentioned be a stand-up pouch, which usually is situated or held in a vertical alignment, this arrangement of the inner pouch guarantees that the second, in particular liquid, reactant moves in the direction of the first reactant solely under the force of gravity. Therefore, the user himself just has to make sure that the inner pouch bursts open. The reactants or chemical components are then automatically mixed without any further action by the user.

In another embodiment of the packaging according to the invention, the inner pouch is filled completely, i.e., without any entrapped air, with a liquid as the second reactant, wherein this filling in particular is not pressurized. An inner pouch filled in this way already bursts open when exposed to a relatively slight pressure.

In yet another embodiment of the packaging according to the invention, the reaction chamber pouch is a stand-up pouch, wherein in this case the bottom of the reaction chamber pouch runs at an angle, in particular perpendicular, to the longitudinal direction. The product packaging pouch is in this case preferably also a stand-up pouch, wherein at least sections of the bottom of the reaction chamber pouch run parallel to the bottom of the product packaging pouch. In this way, the shape of the reaction chamber pouch is essentially adjusted to the product packaging pouch, i.e., is inevitably relatively wide in the area of its bottom, and tapers toward the top. The reaction chamber pouch is thus in particular wider below than at the top in relation to the longitudinal direction. As a result, the reaction chamber pouch holds better in the product packaging pouch.

In still another embodiment of the packaging according to the invention, the product packaging pouch exhibits a cross section expanding opposite the longitudinal direction toward the bottom in a first section (sectional view, cross section) running in the longitudinal direction and/or in a second section (sectional view, cross section) running in a longitudinal direction, which runs perpendicular to the first section, i.e., in two sectional planes running vertically and orthogonally relative to each other. In other words, the product packaging pouch is also in particular wider below than at the top in relation to the longitudinal direction.

The ratio between the area (in cm²) of the outer surface of the reaction chamber pouch and the maximum fill quantity (in cm³) of the product packaging pouch represents a critical factor in optimally imparting the temperature change to the liquid filling and minimizing the risk of the reaction chamber locally overheating, and hence of damage being done to the pouch sheath adjacent thereto, with the chemical reaction underway. Maximum fill quantity refers to the quantity of liquid filling that still fits into the product packaging pouch once the reaction chamber pouch has already been placed in the product packaging pouch. Therefore, another embodiment of the packaging according to the invention provides that the ratio between the area (in cm²) of the outer surface of the reaction chamber pouch and the maximum fill quantity (in cm³) of the product packaging pouch containing the reaction chamber pouch measure at least 0.35, preferably at least 0.45, especially preferably at least 0.5, and/or at most 0.75, preferably at most 0.65, especially preferably at most 0.6.

In another embodiment of the packaging according to the invention, the inner pouch in the filled and/or unfilled state has a lower sealing edge relative to the longitudinal direction, which faces the bottom of the reaction chamber pouch, and hence also the bottom of the product packaging pouch, and has a progression that is irregular, i.e., not straight. It was shown that an irregular progression of the lower sealing edge causes the sealing edge to yield more easily at some locations than at other locations when exposed to pressure. As a result, the lower sealing edge breaks open more easily. The lower sealing edge preferably follows a V-shaped progression, wherein in particular the apex of the V-shaped progression, i.e., the tip of the V, points toward the interior of the inner pouch, thereby forming the point of the sealing edge closest to the middle or upper side of the pouch. In other words, the inner pouch is longer at the lateral edges, meaning the edges of the inner pouch extending essentially in the longitudinal direction, than in an area between the lateral edges, in particular the midpoint between the lateral edges. As a result, the underside of the inner pouch exhibits an inwardly directed funnel shape. The vertex of the V-shaped or funnel-shaped progression has turned out to be the point where the sealing edge breaks open the easiest when pressure is exerted on the inner pouch.

Finally, yet another embodiment of the packaging according to the invention provides that the product packaging pouch and/or reaction chamber pouch and/or inner pouch consists at least partially, preferably entirely, of a plastic composite film, in particular containing polyethylene terephthalate (PET) and/or polyethylene (PE) and/or polypropylene (PP), wherein the plastic composite film of the reaction chamber pouch and/or inner pouch in particular contains a layer comprised of an aluminum film. In particular, the composite film of the reaction chamber pouch and/or inner pouch exhibits an exterior, metalized PET layer and/or an interior, peelable PE layer. There here exists a diffusion barrier for the liquid, at least from the inside out. The composite film of the reaction chamber pouch preferably exhibits a PET layer followed by an aluminum layer on the outside, and a PE layer on the inside. The inner pouch can have the same structural design. In particular, the PET layer has a neutral taste, and protects the reaction chamber pouch. The aluminum layer serves as a barrier layer, and prevents the migration of constituents from the reaction chamber pouch into the liquid filling and/or vice versa. In addition, aluminum is an ideal temperature conductor. In particular a film comprised of PE and PP, preferably a polyolefin film, serves as the sealing layer and contact layer with respect to the reactants and subsequent reaction mixture. This film also prevents the migration of constituents from the reactants into the aluminum layer. The composite film of the product packaging pouch can also be composed of PET and PE.

As stated, the product packaging pouch can be designed as a stand-up pouch, wherein the stand-up pouch known from EP 0 989 069 A2 has proven especially suitable for the present invention.

The latter can consist of a weldable material, with two pouch walls joined together at their lateral edges by one welded seam each, a head end and a bottom end, which is formed by a pouch fold that extends between the two pouch walls with the pouch in an empty state, and at its lower and lateral edges is itself joined with the respectively adjacent pouch wall by welded seams, wherein the lateral welded seam edges of the bottom fold run parallel to each other and to a central vertical axis of the pouch, while the lateral welded seam edges of the pouch walls exhibit a chamfered progression from an area adjacent to the bottom fold converging toward the head end, and wherein at least two divider ribs are stamped out of the wall material in each pouch wall, proceed from the two corner areas between the head end and the respectively adjacent lateral welded seam, exhibit a chamfered progression converging toward the bottom fold, and end freely in a transverse plane containing the transitional area between the parallel and chamfered welded seam edges.

Because only the lateral welded seam edges run parallel to each other in the area of the bottom fold in this embodiment, while the lateral welded seam edges of the pouch walls otherwise converge at a chamfer to the head end, the pouch lying flat when in an empty state is narrower in the head area than in the bottom area. With the pouch in a filled state, when pressing the inlaid bottom fold flat yields the oval bottom, an identical width for the pouch transverse to its vertical axis arises due to the corresponding dimensions of the convergence angle of the chamfered welded seam edges, which can range from about 5 degrees to 10 degrees relative to a vertical in an extension of the adjacent, lateral welded seam edges of the bottom fold. This prevents adjacent, filled pouches on the store shelves from partially overlapping each other, so that the pouches can be tightly grouped side by side, thereby economizing on space. In addition, because the divider ribs stamped out of the wall material are aligned to converge opposite the chamfered welded seam edges, folds are prevented from arising in the material of the pouch walls or at the welded seam edges.

In another embodiment of the product packaging pouch, the lower welded seam edges of the bottom fold can be slightly chamfered starting at a central area from their underside toward the lateral welded seam edges. This slight chamfer prevents an upset pressure from being exerted on the external bottom corners when stacking filled pouches, thereby yielding a better stability for the pouches, which also averts so-called wobbling, which in the known pouches manifested itself as a rocking or swaying by the pouch on the bottom contour as a function of filling and pouch dimensions.

The upper and lower pouch corners are further advantageously rounded, which prevents injuries to the hands in the form of scratches while handling the pouch.

The object is further achieved according to a second teaching of the present invention by a method for manufacturing a packaging for a liquid filling, in particular a packaging of the kind described above, in which at least the following steps are implemented:
providing a product packaging pouch made out of a liquid-tight and elastic material that is open at least on one side, preferably on the upper side viewed in the longitudinal direction;
providing a reaction chamber pouch made out of a liquid-tight and elastic material that is open at least on one side, preferably on the upper side viewed in the longitudinal direction;
providing an inner pouch made out of a liquid-tight and elastic material that is open at least on one side, preferably on the upper side viewed in the longitudinal direction;
filling the reaction chamber pouch with a first solid or liquid reactant;
filling the inner pouch with a second, in particular liquid, reactant;
closing the inner pouch via sealing, in particular heat sealing or ultrasonic sealing (i.e., ultrasonic welding);
placing the inner pouch into the reaction chamber pouch;
closing the reaction chamber pouch via sealing, in particular heat sealing or ultrasonic sealing (ultrasonic welding), wherein the reaction chamber pouch can preferably be evacuated beforehand;
placing the reaction chamber pouch in the product packaging pouch;
filling the product packaging pouch with the liquid filling; and
closing the product packaging pouch via sealing, in particular heat sealing or ultrasonic sealing (ultrasonic welding).

An embodiment of the manufacturing method according to the invention provides that, after placing the reaction chamber pouch in the product packaging pouch and before filling the product packaging pouch with the liquid filling, a spout be placed in the product packaging pouch, and the product packaging pouch be closed via sealing, in particular heat sealing or ultrasonic sealing (ultrasonic welding), wherein the product packaging pouch is subsequently filled by means of the spout.

Finally, the object is achieved according to a third teaching of the present invention by a device for manufacturing a packaging for a liquid filling, in particular a packaging of the kind described above and/or for implementing a method of the kind described above,
with a station that exhibits a unit (an apparatus) for separating and supplying product packaging pouches;
with a gripping mechanism for holding the respectively supplied product packaging pouch;
with a transporting unit (transporting apparatus) for transporting the respective product packaging pouch between consecutive stations;
with a station for manufacturing an inner pouch out of a liquid-tight and elastic material, wherein this station exhibits a filling unit (filling apparatus) for filling the inner pouch with a second reactant, and a sealing unit (sealing apparatus) for closing the inner pouch via sealing;
with a station for manufacturing a reaction chamber pouch out of a liquid-tight and elastic material, wherein this station exhibits a filling unit (filling apparatus) for filling the reaction chamber pouch with a first reactant, a placement unit (placement apparatus) for placing the inner pouch in the reaction chamber pouch, and a sealing unit (sealing apparatus) for sealing the reaction chamber pouch;
with a station that exhibits a unit (an apparatus) for placing the reaction chamber pouch in the product packaging pouch; and
with a station that exhibits a unit (an apparatus) for filling the product packaging pouch with the liquid filling.

An embodiment of the device according to the invention further provides a station that exhibits a unit (an apparatus) for placing a spout and a sealing unit (sealing apparatus) for closing the product packaging pouch via sealing, in particular heat sealing or ultrasonic sealing (ultrasonic welding).

In another embodiment of the device according to the invention, the transporting unit exhibits a star-type reel stand and/or a linear transporter. The star-type reel stand is preferably used to hold and transport the separated product packaging pouches when implementing one or more of the following steps:
Opening the product packaging pouch;
Placing the finished reaction chamber pouch;
Placing the spout in the product packaging pouch;
Joining the spout and product packaging pouch via sealing, in particular heat sealing or ultrasonic sealing (ultrasonic welding); and
Cooling the sealed connection between the spout and product packaging pouch.

A linear transporter encompassing a cartridge with a plurality of product packaging pouches can be situated upstream from the star-type reel stand. For example, a linear transporter situated downstream from the star-type reel stand can be used to receive and transport the product packaging pouch for the following purposes:
Forming a buffer for product packaging pouches provided with a spout and reaction chamber pouch before they are filled with liquid filling;
Filling the product packaging pouch with a liquid filling;
Placing a cover, in particular a cap, on the spout; and
Tightly closing the cover.

There now exists a plurality of ways in which to configure and further develop the packaging according to the invention, the manufacturing method according to the invention and the manufacturing device according to the invention, wherein reference is in this regard made to the claims following to claim 1 on the one hand, and to the description of exemplary embodiments in conjunction with the drawing on the other hand. In the drawing:

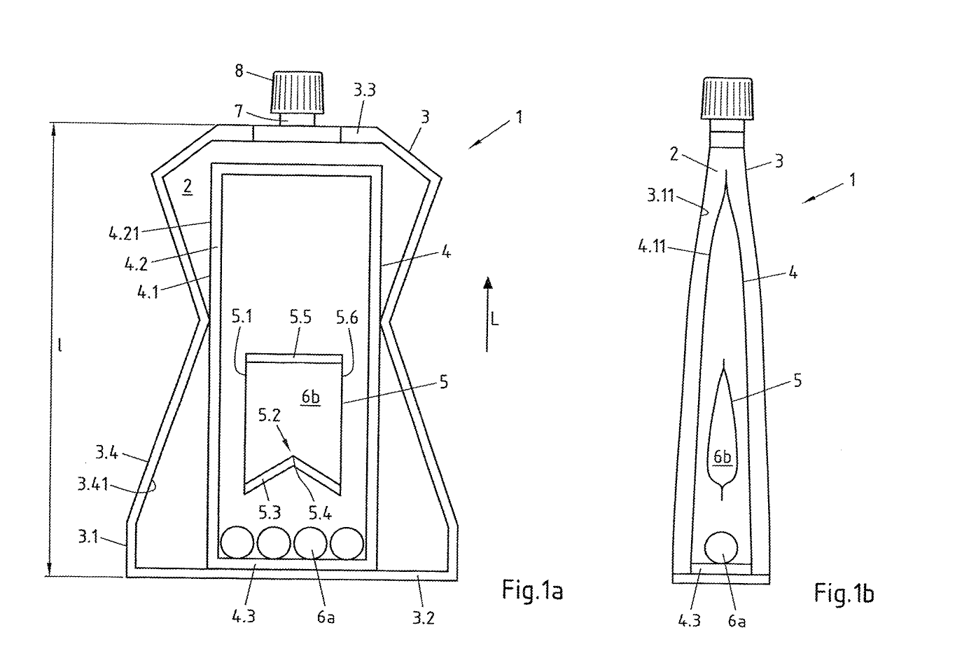

FIGS. 1a) and 1b) show schematic sectional views of a packaging according to the invention along two vertical sectional planes running orthogonally relative to each other;

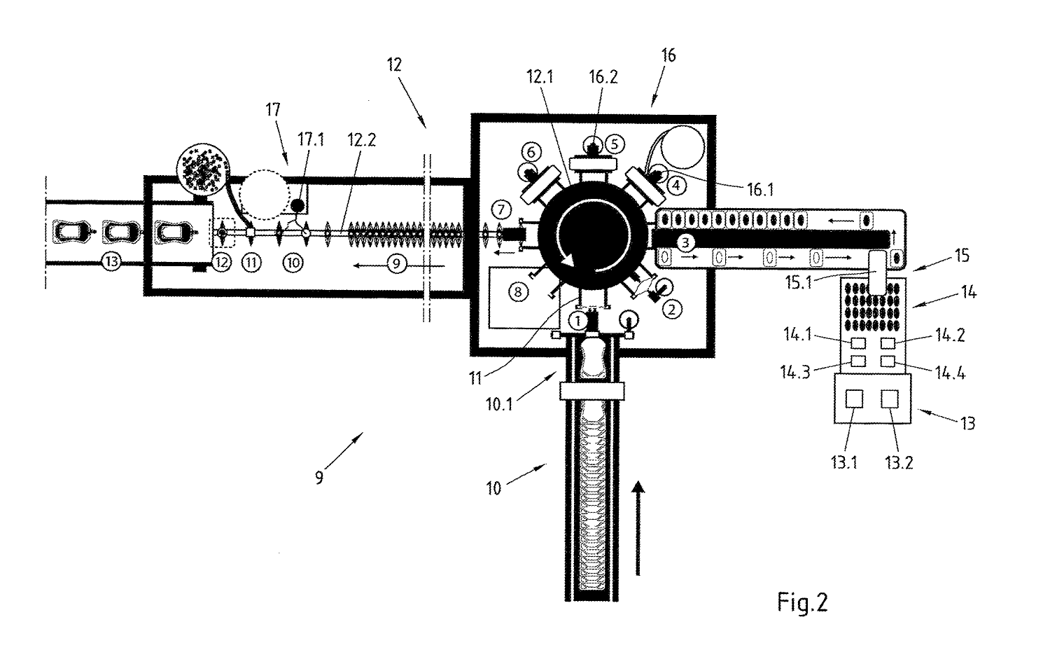

FIG. 2 shows an exemplary embodiment of a manufacturing device according to the invention; and

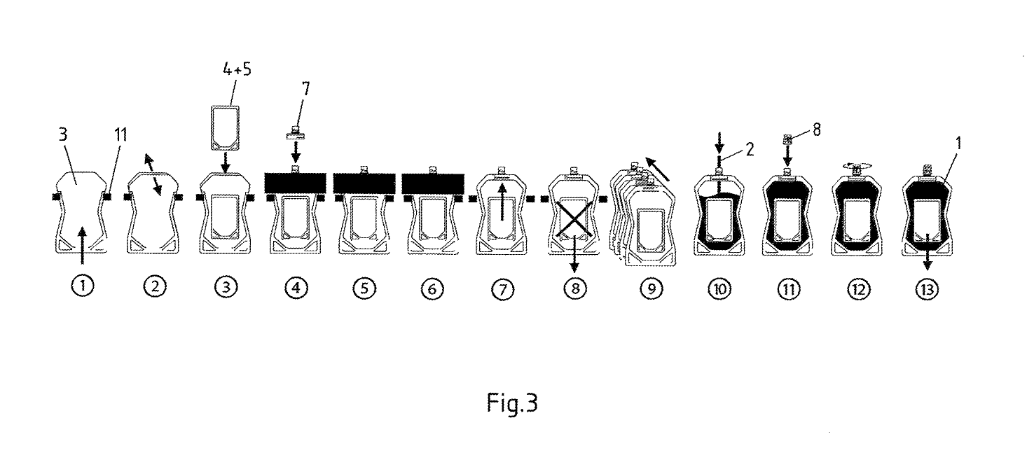

FIG. 3 shows an exemplary embodiment of a manufacturing method according to the invention.

FIGS. 1a) and b) present a schematic view of a packaging 1 for a liquid filling 2, here a beverage. The packaging 1 exhibits a product packaging pouch 3 made out of a liquid-tight and elastic material in the form of a stand-up pouch. The packaging 1 further exhibits a reaction chamber pouch 4 also made out of a liquid-tight and elastic material, wherein the reaction chamber pouch 4 is completely closed, arranged inside the product packaging pouch 3, and partially filled in the lower area with a first solid reactant 6a in the form of tablets.

Finally provided is an inner pouch 5 also made out of a liquid-tight and elastic material, wherein this inner pouch 5 is completely closed, is arranged inside the reaction chamber pouch 4, exhibits a predetermined breaking point 5.2 that yields when the interior pressure is increased, specifically when a pressure is exerted by the user, and is filled with a second, liquid reactant 6b. The first and second reactant are selected, i.e., adjusted relative to each other, in such a way as to induce a temperature change when they come into contact with each other as the result of an endothermic or exothermic reaction.

The product packaging pouch 3, reaction chamber pouch 4 and inner pouch 5 are here each separate pouches consisting of a separate pouch sheath 3.1 or 4.1 or 5.1. The pouches 3, 4 and 5 can here be adjusted relative to each other.

The product packaging pouch 3 exhibits a lower end or a bottom 3.2, from which it extends over a length l in the longitudinal direction L vertical to an upper end 3.3, wherein the reaction chamber pouch 4 in the present case extends in a longitudinal direction over more than 90% of the length l of the product packaging pouch 3.

The inner pouch 5 is arranged vertically above the first reactant 6a, so that the liquid contained therein flows downward under the force of gravity when the pouch 5 bursts open, and comes into contact with the second reactant 6b.

In the filled state of the product packaging pouch 3 depicted here, sections of the reaction chamber pouch 4 are friction fit relative to the product packaging pouch 3. In a tapered area of the product packaging pouch 3, i.e., where the latter is narrowest, the outer edge 4.21 of a lateral sealed seam 4.2 of the reaction chamber pouch 4 is pressed against the inner edge 3.41 of a lateral sealed seam 3.4 of the product packaging pouch 3. As a result, the reaction chamber pouch 4 is held in an optimal position relative to the product packaging pouch 3, so that, in the stand-up pouch form selected for both the product packaging pouch 3 and reaction chamber pouch 4, the reaction chamber pouch is almost completely enveloped by the liquid filling. In the present exemplary embodiment, more than 90% of the outer surface 4.11 of the reaction chamber pouch 4 is here spaced apart from the inner surface 3.11 of the product packaging pouch 3.

As further evident from FIGS. 1a) and b), the product packaging pouch 3 and reaction chamber pouch 4 are wider below than at the top, which provides a certain hold to the reaction chamber pouch 4 in the product packaging pouch 3, and in particular prevents the reaction chamber pouch 4 from floating. Sections of the bottom 4.3 of the reaction chamber pouch 4 here run parallel to the bottom 3.2 of the product packaging pouch 3.

To ensure the clarity of the schematic depiction in the exemplary embodiment shown, the reaction chamber pouch 4 is not presented as evacuated (void of air), even though this is preferred according to the present invention.

FIG. 1a) further shows the exemplary form of the inner pouch 5. The latter has a lower sealing edge 5.3 in relation to the longitudinal direction L, which faces the bottom 4.3 of the reaction chamber pouch 4 and the bottom 3.2 of the product packaging pouch 3. The lower sealing edge 5.3 here has an irregular, specifically V-shaped progression, wherein the apex 5.4 of the V-shaped progression points toward the interior of the inner pouch 5 or toward its upper end 5.5. The length (in the longitudinal direction L) of the inner pouch 5 is thus greater on its lateral edges 5.6 than in the area between.

FIG. 2 shows a device 9 for manufacturing a packaging 1 of the kind described above based on FIGS. 1a) and b). The device 9 is equipped with various stations, which in turn contain individual units, specifically:
with a station 10 that exhibits a unit 10.1 for separating and supplying product packaging pouches 3;
with a gripping mechanism 11 for holding the respectively supplied product packaging pouch 3;
with a transporting unit 12 for transporting the respective product packaging pouch 3 between consecutive stations 10, 15, 16, 17;
with a station 13 for manufacturing an inner pouch 5 out of a liquid-tight and elastic material, wherein this station 13 exhibits a filling unit 13.1 for filling the inner pouch 5 with a second reactant 6b, and a sealing unit 13.2 for closing the inner pouch 5 via sealing;
with a station 14 for manufacturing a reaction chamber pouch out 4 of a liquid-tight and elastic material, wherein this station 14 exhibits a filling unit 14.1 for filling the reaction chamber pouch 4 with a first reactant 6a, a placement unit 14.2 for placing the inner pouch 5 in the reaction chamber pouch 4, and a sealing unit 14.3 for sealing the reaction chamber pouch 4;
with a station 15 that exhibits a unit 15.1 for placing the reaction chamber pouch 4 in the product packaging pouch 3;
with a station 16 that exhibits a unit 16.1 for placing a spout 7 and a sealing unit 16.2 for closing the product packaging pouch for sealing purposes; and
with a station 17 that exhibits a unit 17.1 for filling the product packaging pouch 3 with the liquid filling 2.

The transporting unit 12 here exhibits a star-type reel stand 12.1 and a linear transporter 12.2 situated downstream from the latter.

The described device 9 is here suitable for implementing a method involving the following procedural steps:
providing a product packaging pouch 3 made out of a liquid-tight and elastic material that is open at least on one side;
providing a reaction chamber pouch 4 made out of a liquid-tight and elastic material that is open at least on one side;
providing an inner pouch 5 made out of a liquid-tight and elastic material that is open at least on one side;
filling the reaction chamber pouch 4 with a first reactant 6a;
filling the inner pouch 5 with a second reactant 6b;
closing the inner pouch 5 via sealing;
placing the inner pouch 5 in the reaction chamber pouch 4;
closing the reaction chamber pouch 4 via sealing;
placing the reaction chamber pouch 4 in the product packaging pouch 3;
filling the product packaging pouch 3 with the liquid filling 2; and
closing the product packaging pouch 3 via sealing.

The method according to the invention will be explained once more in detail based on FIG. 3, wherein the individually implemented procedural steps or actions are marked with circled numbers on FIGS. 2 and 3, and mean as follows:
(1) supplying and separating product packaging pouches 3
(2) opening the product packaging pouch 3
(3) placing a respective reaction chamber pouch 4 provided with an inner pouch 5 in the product packaging pouch 3
(4) placing a spout 7 in the product packaging pouch 3
(5) joining the spout 7 and product packaging pouch 3 via sealing
(6) cooling the sealed connection
(7) outputting the product packaging pouch 3 provided with the spout 7 and reaction chamber pouch 4
(8) outputting flawed product packaging pouches 3
(9) buffering and transporting the product packaging pouches 3 to the filling station 17
(10) filling the product packaging pouch 3 with the liquid filling 2
(11) placing a cover 8 on the spout 7
(12) tightly screwing the cover 8 on the spout 7, and
(13) outputting a finished packaging 1.

1. A packaging for a liquid filling, in particular a liquid food or non-food,
with a product packaging pouch made out of a liquid-tight and elastic material,
with a reaction chamber pouch made out of a liquid-tight and elastic material, wherein the reaction chamber pouch is completely closed, arranged inside the product packaging pouch and partially filled with a first reactant, and
with an inner pouch made out of a liquid-tight and elastic material, wherein the inner pouch is completely closed, arranged inside the reaction chamber pouch, and filled with a second reactant,
wherein the first and second reactant induce a temperature change upon coming into contact with each other,
wherein the reaction chamber pouch is completely closed, and
wherein the inner pouch exhibits a predetermined breaking point that yields when its interior pressure is increased.

2. The packaging according to claim 1, wherein the product packaging pouch and reaction chamber pouch each have a separate pouch sheath.

3. The packaging according to claim 1, wherein the reaction chamber pouch and inner pouch each have a separate pouch sheath.

4. The packaging according to claim 1, wherein the product packaging pouch has a lower end that comprises a bottom, from which the product packaging pouch extends over a length vertically in the longitudinal direction toward an upper end, wherein the reaction chamber pouch extends in the longitudinal direction over at least 50%.

5. The packaging according to claim 1, wherein the inner pouch is situated vertically above the first reactant in the reaction chamber pouch relative to the longitudinal direction.

6. The packaging according to claim 1, wherein the inner pouch is completely filled with a liquid as the second reactant.

7. The packaging according to claim 1, wherein at least sections of the reaction chamber pouch are friction fit relative to the product packaging pouch with the product packaging pouch in a filled and/or unfilled state.

8. The packaging according to claim 7, wherein the product packaging pouch and reaction chamber pouch each exhibit at least one lateral sealed seam and, with the product packaging pouch in a filled and/or unfilled state, the outer edge of a lateral sealed seam of the reaction chamber pouch abuts against the inner edge of a lateral sealed seam of the product packaging pouch.

9. The packaging according to claim 1, wherein the product packaging pouch has a tapered form when in the filled and/or unfilled state.

10. The packaging according to claim 1, wherein more than 50% of the outer surface of the reaction chamber pouch is spaced apart from the inner surface of the product packaging pouch with the product packaging pouch in the filled state.

11. The packaging according to claim 1, wherein the reaction chamber pouch is evacuated.

12. The packaging according to claim 1, wherein the reaction chamber pouch is a stand-up pouch, whose bottom runs at an angle to the longitudinal direction.

13. The packaging according to claim 12, wherein the product packaging pouch is a stand-up pouch, wherein at least sections of the bottom of the reaction chamber pouch run parallel to the bottom of the product packaging pouch.

14. The packaging according to claim 1, wherein the reaction chamber pouch is wider below than at the top relative to the longitudinal direction.

15. The packaging according to claim 1, wherein the product packaging pouch exhibits a cross section expanding opposite the longitudinal direction toward the bottom in a first section running in the longitudinal direction and/or in a second section running in a longitudinal direction, which runs perpendicular to the first section.

16. The packaging according to claim 1, wherein the ratio between the area in cm² of the outer surface of the reaction chamber pouch and the maximum fill quantity in cm³ of the product packaging pouch containing the reaction chamber measures at least 0.35 and/or at most 0.75.

17. The packaging according to claim 1, wherein the inner pouch in the filled and/or unfilled state has a lower sealing edge relative to the longitudinal direction, which faces the bottom of the reaction chamber pouch, and has an irregular progression.

18. The packaging according to claim 17, wherein the lower sealing edge has a V-shaped progression.

19. The packaging according to claim 1, wherein the product packaging pouch and/or reaction chamber pouch and/or inner pouch consist at least partially of a plastic composite film.

20. A method for manufacturing a packaging for a liquid filling according to claim 1, in which at least the following steps are implemented:
providing a product packaging pouch made out of a liquid-tight and elastic material that is open at least on one side;
providing a reaction chamber pouch made out of a liquid-tight and elastic material that is open at least on one side;
providing an inner pouch made out of a liquid-tight and elastic material that is open at least on one side;
filling the reaction chamber pouch with a first reactant;
filling the inner pouch with a second reactant;
closing the inner pouch via sealing;
placing the inner pouch in the reaction chamber pouch;
completely closing the reaction chamber pouch via sealing;
placing the reaction chamber pouch in the product packaging pouch;
filling the product packaging pouch with the liquid filling; and
closing the product packaging pouch via sealing.

21. The method according to claim 20, wherein, after placing the reaction chamber pouch in the product packaging pouch and before filling the product packaging pouch with the liquid filling, a spout is placed in the product packaging pouch, and the product packaging pouch is closed via sealing, wherein the product packaging pouch is subsequently filled by means of the spout.

22. A device for manufacturing a packaging for a liquid filling according to claim 1,
with a station that exhibits a unit for separating and supplying product packaging pouches;
with a gripping mechanism for holding the respectively supplied product packaging pouch;
with a transporting unit for transporting the respective product packaging pouch between consecutive stations;
with a station for manufacturing an inner pouch out of a liquid-tight and elastic material, wherein this station exhibits a filling unit for filling the inner pouch with a second reactant, and a sealing unit for closing the inner pouch via sealing;
with a station for manufacturing a reaction chamber pouch out of a liquid-tight and elastic material, wherein this station exhibits a filling unit for filling the reaction chamber pouch with a first reactant, a placement unit for placing the inner pouch in the reaction chamber pouch, and a sealing unit, wherein the sealing unit is hence configured in such a way that the reaction chamber pouch can be completely closed;
with a station that exhibits a unit for placing the reaction chamber pouch in the product packaging pouch; and
with a station that exhibits a unit for filling the product packaging pouch with the liquid filling.

23. The device according to claim 22, wherein a station is provided that exhibits a unit for placing a spout and a sealing unit for closing the product packaging pouch.

24. The device according to claim 22, wherein the transporting unit exhibits a star-type reel stand and/or a linear transporter.
